(19) United States
(12) Patent Application Publication
(10) Pub. No.: US 2018/0230045 A1
(43) Pub. Date: Aug. 16, 2018

(54) GLASS RESIN LAMINATE

(71) Applicant: ASAHI GLASS COMPANY, LIMITED, Chiyoda-ku (JP)

(72) Inventor: Hiroyuki OHKAWA, Tokyo (JP)

(73) Assignee: ASAHI GLASS COMPANY, LIMITED, Chiyoda-ku (JP)

(21) Appl. No.: 15/952,465

(22) Filed: Apr. 13, 2018

Related U.S. Application Data
(63) Continuation of application No. PCT/JP2016/080580, filed on Oct. 14, 2016.

(30) Foreign Application Priority Data
Oct. 16, 2015 (JP) 2015-204413

(51) Int. Cl. C03C 21/00; B32B 17/10

(52) U.S. Cl. CPC C03C 21/002; B32B 2457/202; B32B 17/10

(57) ABSTRACT

A glass resin laminate includes a sheet glass having a compressive stress layer formed in a main surface thereof and a resin layer provided on the sheet glass. A surface compressive stress in the main surface of the sheet glass is 200 MPa or more. A depth of the compressive stress layer is 3 μm or more. A central tension CT (MPa) and a sheet thickness t (mm) of the sheet glass satisfy the equations CT≤64.1× t^{-0.703} (4) and CT>−38.7×ln(t)+48.2 (5).

### TECHNICAL FIELD

The present invention relates to a glass resin laminate.

### BACKGROUND ART

In a variety of applications, such as electronic instruments represented by a smartphone or an electronic paper, in-vehicle display members to be provided in an automobile or an electronic car, solar cell modules, lightings, etc., a so-called chemically strengthened glass is used as a cover member. In recent years, for the purpose of performing weight reduction of an instrument or the like using a glass, the thickness of the glass is becoming thin.

Patent Document 1 discloses a method of regulating a frangible behavior of a strengthened glass when on defining a central tension CT of an inner region of glass as “CT=CS×DOL/(t−2×DOL)” (equation (1)) from a compressive stress CS and a depth of layer DOL in an outer region, the value of CT is allowed to fall within a certain numerical value range. According to this method, a function of glass thickness named as a nonlinear threshold central tension CT₁ (unit: MPa) is defined as “CT₁=−38.7×ln(t)+48.2” (equation (2)) on the basis of the working examples of aluminosilicate glasses having a sheet thickness t of 0.3 to 1.5 mm. The value of this CT₁ is proposed as an upper limit of the value of the central tension CT and defined as a critical value of the onset of unacceptable frangible behavior. It is mentioned that in certain applications using a thinner glass sheet, the design flexibility is limited on the basis of the equation (2).

### CITATION LIST

### Patent Document

Patent Document 1: JP-A-2011-530470

### SUMMARY OF INVENTION

### Problems that the Invention is to Solve

Hitherto, in order to enhance the strength of a strengthened glass, it has been attempted to increase the value of surface compressive stress (CS) or depth of compressive stress layer (DOL). However, as expressed in the equation (1), by increasing the value of CS or DOL, the central tension (CT) became large, too, a value of which was limited by the upper limit expressed by the equation (2). In consequence, the upper limits of CS and DOL were also substantially limited.

Here, the equation (2) for regulating a breakage behavior of the strengthened glass to be used for cover glass, etc., was based on the evaluation of breakage tests against a cover glass alone. In consequence, the breakage behavior in a state where a cover glass and a casing of an electronic instrument are integrated has not been investigated.

Then, an object of the present invention is to provide a glass resin laminate, in which it is possible to set the CS and the DOL of a cover glass to higher values than the background-art values, and for which even after broken, a user is able to use temporarily with good operability.

### Means for Solving the Problems

Specifically, the present invention provides the following glass resin laminates.

[1] A glass resin laminate including a sheet glass having a compressive stress layer formed in a main surface thereof and a resin layer provided on the sheet glass, wherein a surface compressive stress in the main surface of the sheet glass is 200 MPa or more, a depth of the compressive stress layer is 3 μm or more, and a central tension CT (MPa) and a sheet thickness t (mm) of the sheet glass satisfy the following equations (4) and (5):

CT≤64.1×t^{-0.703} (4)

CT>−38.7×ln(t)+48.2 (5).

[2] The glass resin laminate as set forth in [1], wherein a Young's modulus of the resin layer is 0.01 to 10 MPa.
[3] The glass resin laminate as set forth in [1] or [2], wherein an adhesion of the resin layer to the sheet glass is 10 to 1,000 N/m².
[4] The glass resin laminate as set forth in any one of [1] to [3], wherein a safety index of the sheet glass is 2 or more.
[5] The glass resin laminate as set forth in any one of [1] to [4], which is used for an electronic instrument including a liquid crystal display device and disposed for use such that the resin layer intervenes between the sheet glass and the liquid crystal display device.

### Advantage of Invention

According to the disclosed art, it is possible to provide a glass resin laminate, in which it is possible to set the CS and the DOL of a cover glass to higher values than the background-art values, and for which even after broken, a user is able to use with good operability.

### BRIEF DESCRIPTION OF THE DRAWINGS

FIG. 1 is a view explaining a breakage behavior of a sheet glass alone.

FIG. 2 is a view explaining a breakage behavior of a sheet glass in a configuration where a resin intervenes between a cover glass and a casing of an electronic instrument.

FIG. 3 is a schematic view showing one configuration of a glass resin laminate according to the present embodiment.

FIG. 4 is a schematic view of a breakage behavior of a glass resin laminate including a sheet glass having a CT value of not more than a CT₄ value.

FIG. 5 is a schematic view of a breakage behavior of a glass resin laminate including a sheet glass having a CT value of more than a CT₄ value.

FIG. 6 is a view explaining a measuring method of a surface level difference of a sheet glass in the case where in a glass resin laminate according to the present embodiment, a resin layer intervenes between a sheet glass and an electronic instrument casing.

FIG. 7 is a graph explaining a relation between the sheet thickness and the CT₁ value or the CT₄ value in a sheet glass included in the glass resin laminates of Examples 1 to 47.

### MODE FOR CARRYING OUT THE INVENTION

Embodiments for carrying out the present invention are hereunder described by reference to the accompanying drawings. In the respective drawings, the same structural portions are assigned the same reference numerals and symbols, and overlapping explanations thereof are occasionally omitted.

In addition, in the present specification, the term “% by mass” is synonymous with the term “% by weight”.

In a glass resin laminate according to the embodiment, a sheet glass 10 is disposed on an electronic instrument casing 40 via a resin layer 20. (The details are described later.)

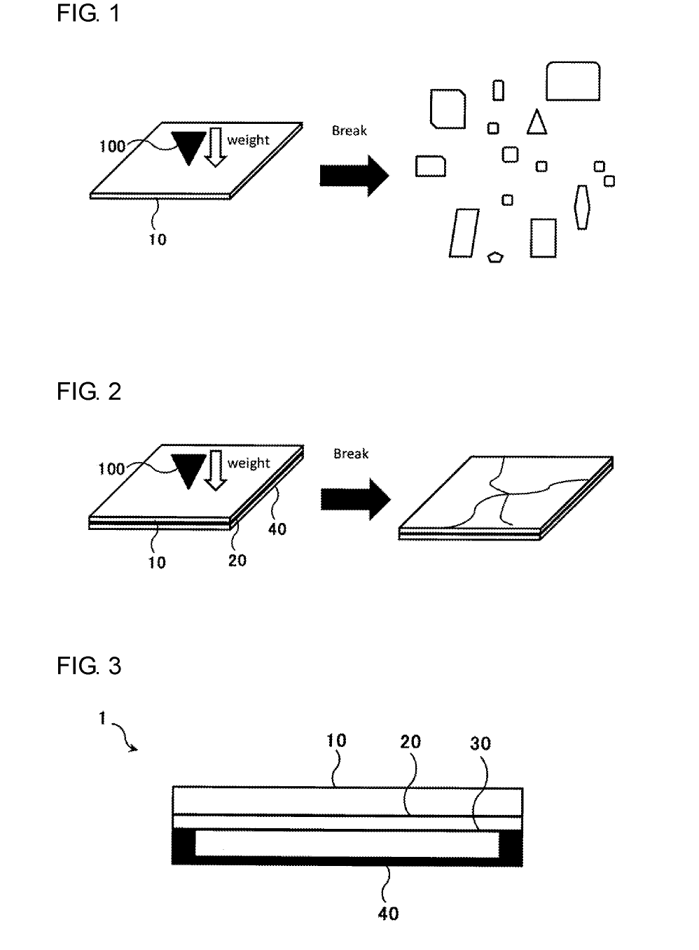

As a result of extensive and intensive investigations made by the inventor of this application, it has been found that in the case of a configuration where a resin layer intervenes between a cover glass and an electronic instrument casing (in particular, a liquid crystal display member) in this way, a breakage behavior of the cover glass is different. For example, between the sheet glass alone as shown in FIG. 1 and the configuration where a resin intervenes between the cover glass and the electronic instrument casing as shown in FIG. 2, the breakage behavior of the sheet glass or a degree of its scatter was significantly different. Then, it has been found that in the case of the configuration where a resin intervenes between the cover glass and the electronic instrument casing, the upper limit expressed in the equation (2) does not exist, so that it is possible to set the CS and the DOL to higher values than the background-art values (focus point 1).

In addition, it has also been found that in the configuration where a resin intervenes between the cover glass and the electronic instrument casing, there is a case where even after the cover glass is broken, the cover glass and the resin keep the adhered state depending upon a breakage way thereof, thereby making it possible to use the configuration as a protective sheet of the electronic instrument. Then, on using the resultant in such a state, though a level difference (unevenness) to be caused due to cracking is generated on the cover glass surface, a new problem such that the operability of a user alters in the level difference of cracking is generated. The inventor of this application has found that it is possible to solve such a problem of operability by controlling chemical strengthening properties of the cover glass, namely the stress profile (focus point 2).

In view of the above-described focus points 1 and 2, in the present embodiment, a glass resin laminate, in which it is possible to set the CS and the DOL of a cover glass to higher values than the background-art values, and for which even after broken, a user is able to use temporarily with good operability, is provided.

### (Shape and Physical Properties of Sheet Glass)

The sheet glass according to the present embodiment is generally in a sheet-like shape, but may be a planar sheet or a bent-processed glass sheet. The sheet glass according to the present embodiment is not particularly limited with respect to a production method thereof. The sheet glass according to the present embodiment is a glass sheet which has been molded in a planar sheet shape by a known glass molding method, such as a float method, a fusion method, a slot downdraw method, etc. The sheet glass according to the present embodiment can be produced by putting desired glass raw materials into a continuous melting furnace; heat melting the glass raw materials preferably at 1,500 to 1,600° C.; and after refining, feeding the resultant into a molding apparatus to mold the molten glass into a sheet shape, followed by gradually cooling. It is preferred the sheet glass has a liquid phase viscosity of 130 dPa·s or more.

The sheet glass according to the present embodiment has a size such that it is moldable according to an already existing molding method. That is, when molded by the float method, a ribbon-shaped glass having a continuous float-molding width can be obtained. In addition, the sheet glass according the present embodiment is finally cut into a size suitable for the intended use.

The sheet thickness t of the sheet glass according to the present embodiment is 2.0 mm or less for the purpose of contribution to weight reduction. As the sheet thickness of the glass is thinner, even when a central tension CT is increased to a value higher than the background-art value, the operability is not deteriorated. The sheet thickness t is preferably 1.5 mm or less, more preferably 1.0 mm or less, still more preferably 0.7 mm or less, yet still more preferably 0.5 mm or less, especially preferably 0.3 mm or less, and most preferably 0.2 mm or less.

In order to provide a compressive stress layer deeply to some extent, the sheet thickness t of the sheet glass according to the present embodiment is preferably 0.05 mm or more. When the sheet glass has a sheet thickness t of 0.05 mm or more, it is possible to make the DOL at least to 3 μm or more by the chemical strengthening process. The sheet thickness t is more preferably 0.07 mm or more, and more preferably 0.1 mm or more. In order to obtain a larger DOL, it is preferred to set the sheet thickness t to 0.1 mm or more. According to this, when the glass is largely bent, it is possible to prevent breakage from the end surface from occurring.

The sheet glass according to the present embodiment can be used as a cover glass and a touch sensor glass of a touch panel display equipped in information instruments, such as tablet PCs, notebook-size PCs, smartphones, e-book readers, etc., a cover glass of liquid crystal televisions, PC monitors, etc., a cover glass of automobile instrument panels, etc., a cover glass for solar cells, a multilayer glass for use in interior materials of building materials and windows of buildings and houses, and the like. That is, the sheet glass according to the present embodiment has a size suitable for intended applications, such as a size of a display of tablet PCs or smartphones, etc., or a size of a cover glass for solar cells.

The sheet glass according to the present embodiment is generally cut in a rectangle form, but may also be in any other form, such a circle, a polygon, etc., with no problem, and a perforated glass is also included.

The sheet glass according to the present embodiment is a chemically strengthened glass in which a compressive stress layer is provided in a glass surface layer by the chemical strengthening process. A surface compressive stress (CS) of the sheet glass is preferably 200 MPa or more, and more preferably 300 MPa or more, 400 MPa or more, 500 MPa or more, 600 MPa or more, 700 MPa or more, 800 MPa or more, 900 MPa or more, and 1,000 MPa or more. When the CS is 200 MPa or more, scratches are hardly generated on the glass surface.

When scratches having a depth of more than the value of the depth of compressive stress layer (DOL) are generated at the time of using the sheet glass, it leads to destruction of the sheet glass, and therefore, the DOL of the sheet glass is preferred to be deeper. The DOL is preferably 3 μm or more, and more preferably 4 μm or more, 5 μm or more, 6 or more, 7 μm or more, 8 μm or more, 9 μm or more, 10 μm or more, 12 μm or more, 15 μm or more, and 20 μm or more.

The central tension CT of the sheet glass according to the present embodiment (hereinafter referred to simply as central tension CT) can be calculated according to “CT=CS×DOL/(t−2×DOL)” (equation (1)) or the equation (3) shown below. Here, t is a sheet thickness (μm) of the sheet glass; DOL is a depth (μm) of the compressive stress layer; CS is a surface compressive stress value (MPa); and CS(x) is a compressive stress value (MPa) at a position x in the depth direction of the sheet glass, namely a stress profile. The unit of CT is (MPa).

$$\begin{matrix}[ Math . 1 ] & \\ C T = \frac{2 \times {\int }_{0}^{DOL} C S ( x ) dx}{( t - 2 \times D O L )} & ( 3 )\end{matrix}$$

The equation (1) is a calculation equation to be applied for a chemically strengthened glass having a so-called complementary error function profile in which approximation of the stress profile of the glass interior to a linear function (hereinafter also referred to as triangle approximation) is relatively permissible. In the chemically strengthened glass having a complementary error function profile, an error in the value of CT obtained between the equation (1) and the equation (3) is small, and the value of the equation (3) falls within a range of ±5% of the value of CT obtained according to the equation (1). In the chemically strengthened glass having such a complementary error function profile, the value of CT is determined according to the equation (1).

On the other hand, a chemically strengthened glass in which an error in the value of CT obtained between the equation (1) and the equation (3) is large, and the value of the equation (3) does not fall within a range of ±5% of the value of CT obtained according to the equation (1) is named as a chemically strengthened glass having a non-complementary error function profile. In the chemically strengthened glass having a non-complementary error function profile, the value of CT is determined according to the equation (3).

The CS and the DOL can be measured with a glass surface stress meter (FSM-6000LE, manufactured by Orihara Industrial Co., Ltd.). The CS(x) can be measured with a glass surface stress meter (FSM-6000LE/IR, manufactured by Orihara Industrial Co., Ltd.).

When the central tension CT of the sheet glass according to the present embodiment satisfies “CT≤64.1× t^{-0.703}” (equation (4)), even in the case where cracks are generated on the surface of the sheet glass, the glass pieces do not become excessively small and are adhered to the resin layer, and therefore, a surface level difference (unevenness) to be caused due to the cracks is hardly generated. Here, t is the sheet thickness (mm) of the sheet glass, and the right side of the equation (4) is the upper limit value of the central tension CT of the sheet glass, which the inventor of this application has been found as a result of extensive and intensive investigations. In the sheet glass of the present embodiment to be laminated with the resin layer, by controlling the central tension CT within the numerical value range satisfying the equation (4), the surface level difference (unevenness) in the case where cracks are generated on the surface of the sheet glass can be regulated. Grounds of the right side of the equation (4) are described later.

In order to make the CS and the DOL close to more preferred values, the central tension CT of the sheet glass according to the present embodiment is preferably 30 MPa or more, and more preferably 50 MPa or more, 70 MPa or more, 100 MPa or more, 120 MPa or more, 150 MPa or more, and 200 MPa or more. In addition, for suitably enhancing the CS and the DOL, in order to make it possible to realize a material design different from the background-art material design, the central tension CT is made larger than the CT₁ value to be determined according to the equation (2), namely the central tension CT is made to satisfy “CT>−38.7× ln(t)+48.2” (equation (5)).

### (Safety Index)

The operability of the glass resin laminate in the case where cracks have been generated on the surface of the sheet glass can be evaluated according to the following safety index. The safety index can be classified into three grades as shown in Table 1 depending upon the surface level difference (unevenness) when a Vickers indenter (diamond square pyramid indenter with an angle between the opposite faces of 136°) is freely fallen on the surface of the sheet glass from a height of 30 mm in a state where the Vickers indenter is attached with a weight of 10 g, and the Vickers indenter is collided at a rate of about 0.8 msec on the surface side of the sheet glass to destruct the sheet glass. The surface level difference (unevenness) after destruction is measured with a surface texture and contour measuring instrument (SURFCOM 1400D, manufactured by Tokyo Seimitsu Co., Ltd.).

TABLE 1

| Surface level difference (unevenness) after breaking up | Safety index |
|---|---|
| More than 5 μm | 1 |
| More than 1 μm and 5 μm or less | 2 |
| 1 μm or less | 3 |

The case where the safety index is 2 or more is preferred because a glass resin laminate which even after the sheet glass is broken, the user is able to use with good operability can be provided. The case where the safety index is 3 is more preferred because the user cannot confirm cracks of the sheet glass by a finger, so that a glass resin laminate that is usable with good operability can be provided.

### (Glass for Chemical Strengthening)

A composition of the sheet glass which is used for producing the chemically strengthened glass of the present embodiment is described by using contents expressed in terms of mol % unless otherwise specified.

SiO₂ is known as a component that forms a network structure in a glass microstructure. The content of SiO₂ is preferably 60% or more, and more preferably 61% or more, 62% or more, 63% or more, 64% or more, 65% or more, 66% or more, and 67% or more. In addition, the content of SiO₂ is preferably 72% or less, and more preferably 71% or less, 70% or less, and 69% or less. When the content of SiO₂ is 60% or more, it is advantageous in view of stability and weather resistance as a glass. On the other hand, when the content of SiO₂ is 72% or less, it is advantageous in view of meltability and moldability.

Al₂O₃ has an effect to improve chemical strengthening properties in the chemical strengthening, and in particular, its effect to improve the CS is large. Al₂O₃ is also known as a component that improves weather resistance of the glass. In addition, Al₂O₃ has an effect to inhibit invasion of tin from the bottom surface at the time of float molding. Furthermore, Al₂O₃ has an effect to promote dealkalization on performing the SO₂ treatment. The content of Al₂O₃ is preferably 1% or more, more preferably 3% or more, 5% or more, 7% or more, and 9% or more, and still more preferably 10% or more. In addition, the content of Al₂O₃ is preferably 30% or less, and more preferably 20% or less, 18% or less, 16% or less, 15% or less, and 14% or less. When the content of Al₂O₃ is 1% or more, a desired CS value is obtained by ion exchange, and an effect for inhibiting invasion of tin, an effect of stability against a change of the moisture content, and a dealkalization promoting effect are obtained. On the other hand, when the content of Al₂O₃ is 30% or less, it is advantageous in view of the matter that the DOL value does not become excessively large, and the CT value can be suppressed to a fixed value or less.

MgO is a component that stabilizes the glass. The content of MgO is preferably 1% or more, and more preferably 2% or more, 3% or more, and 4% or more. In addition, the content of MgO is preferably 12% or less, and more preferably 11% or less, 10% or less, 9% or less, 8% or less, and 7% or less. When the content of MgO is 1% or more, meltability at high temperatures becomes favorable, and devitrification hardly occurs. On the other hand, when the content of MgO is 11% or less, unlikeliness of occurrence of devitrification is kept, and a sufficient ion exchange rate is obtained.

CaO is a component that stabilizes the glass. Though CaO does not have to be contained, when CaO is contained, the content thereof is preferably 3% or more, and more preferably 4% or more, 5% or more, more than 5%, 6% or more, and 7% or more. In addition, the content of CaO is preferably 10% or less, and more preferably 9% or less and 8% or less. In particular, when the content of CaO is more than 5%, the DOL value does not become excessively large, and the CT value can be suppressed to a fixed value or less. On the other hand, where the content of CaO is 9% or less, a sufficient ion exchange range is obtained, and a desired DOL value is obtained.

Na₂O is a component that forms the compressive stress layer by ion exchange and has an effect to make the DOL deep. In addition, Na₂O is a component that decreases high-temperature viscosity and devitrification temperature and improves meltability and moldability of the glass. Na₂O is a component that bears non-bridge oxygen (NBO), whereby when the moisture content in the glass changes, a fluctuation of the chemical strengthening properties becomes small. The content of Na₂O is preferably 10% or more, and more preferably 11% or more, 12% or more, and 13% or more. In addition, the content of Na₂O is preferably 18% or less, and more preferably 17% or less and 16% or less. When the content of Na₂O is 10% or more, a desired compressive stress layer can be formed by ion exchange, and a fluctuation against a change of the moisture content is suppressed, too. On the other hand, when the content of Na₂O is 18% or less, sufficient weather resistance is obtained, the invasion amount of tin from the bottom surface at the time of float molding can be inhibited, and after the chemical strengthening process, the glass is hardly warped.

A sum total of the contents of SiO₂, Al₂O₃, MgO, and Na₂O is preferably 95% or more. When the foregoing sum total is 95% or more, a desired compressive stress layer can be obtained while keeping cracking resistance. The sum total is more preferably 96% or more, 97% or more, 98% or more, 98.5% or more, and 99% or more.

K₂O is a component that has an effect for increasing the ion exchange rate and making the DOL deep and increases the non-bridge oxygen, and therefore, in the case where K₂O is contained, the content thereof is preferably 5% or less, and more preferably 4% or less, 3% or less, 2% or less, 1% or less, 0.8% or less, and 0.6% or less. In particular, when the content of K₂O is 1% or less, the DOL does not become excessively deep, and a sufficient CS is obtained. In addition, K₂O in a small amount has an effect for inhibiting the invasion of tin from the bottom surface at the time of float molding, and therefore, it is preferred that K₂O is contained on performing float molding. In this case, the content of K₂O is preferably 0.05% or more, and more preferably 0.1% or more.

Al₂O₃ has an effect to improve the CS, whereas Na₂O has an effect to make the DOL deep and simultaneously to lower the CS. In addition, K₂O has an effect to increase the ion exchange rate and to make the DOL deep. In consequence, when Al₂O₃, Na₂O, and K₂O are contained in a specified ratio, it becomes possible to increase the CS value, thereby achieving cutting after the chemical strengthening process. A ratio of (Na₂O+K₂O)/Al₂O₃ is preferably 8 or less, and more preferably 7 or less, 6 or less, and 5 or less.

Al₂O₃ is a component that increases the high-temperature viscosity and the devitrification temperature, whereas Na₂O and K₂O are a component that decreases the both. When the (Na₂O+K₂O)/Al₂O₃ ratio is 1.8 or more, the high-temperature viscosity becomes low, and the devitrification temperature also becomes low. In addition, it is possible to make the DOL sufficiently deep. In addition, Al₂O₃ is a component that decreases the non-bridge oxygen, whereas Na₂O and K₂O are a component that increases the non-bridge oxygen. For the purposes of stably producing the glass, keeping the DOL necessary for improving the strength, and obtaining stable chemical strengthening properties against a change of the moisture content, the (Na₂O+K₂O)/Al₂O₃ ratio is preferably 1.8 or more, and more preferably 2 or more, 3 or more, and 4 or more.

In the case of chemically strengthening a glass having the same matrix composition but a different moisture content, the CS value decreases with an increase of the moisture content, whereas the DOL value does not significantly rely on the moisture content to such an extent that it slightly decreases with an increase of the moisture content. Furthermore, when the content of Na₂O or K₂O increases, the change of CS when the moisture content changes becomes small. It may be considered that this is caused due to the increase of non-bridge oxygen in the glass. On the other hand, when the content of Al₂O₃ increases, the non-bridge oxygen in the glass decreases. In a glass containing 1% or more of Al₂O₃, in order to obtain stable chemical strengthening properties without relying on the moisture content, the (Na₂O+K₂O)/Al₂O₃ ratio is preferably 1.8 or more.

In a glass formed by the float method, the content of Al₂O₃ in the glass affects the tin invasion, and when the Al₂O₃ component increases, it acts to inhibit the tin invasion. At the same time, the content of the alkali component, namely the content of Na₂O also affects the tin invasion, and the alkali component has an act to allow the tin invasion to grow presumptuous. In consequence, by keeping the value of Na₂O/Al₂O₃ in an appropriate range, the tin invasion on molding by the float method, thereby making it possible to reduce a warpage of the glass after the chemical strengthening.

When attention is paid to the two components of Al₂O₃ and Na₂O, they have reciprocal effects regarding CS and DOL, high-temperature viscosity, devitrification temperature, and invasion amount of tin from the bottom surface. It is preferred that Al₂O₃ and Na₂O are contained in a specified ratio, and in order to increase the CS value and to decrease the invasion amount of tin, the Na₂O/Al₂O ratio is preferably 7 or less, more preferably 6 or less, and still more preferably 5 or less. On the other hand, in order to keep the DOL necessary for improving the strength and to inhibit increases of high-temperature viscosity and devitrification temperature, the Na₂O/Al₂O ratio is preferably 1.5 or more, and more preferably 2 or more, 3 or more, and 4 or more.

A plenty of TiO₂ is existent in natural raw materials, and it is known that TiO₂ becomes a yellow coloring source. The content of TiO₂ is 2% or less, preferably 1% or less, and more preferably 0.5% or less. When the content of TiO₂ is 2% or less, the glass hardly becomes yellowish.

Fe₂O₃ is existing in any place of the natural would and production lines, and therefore, Fe₂O₃ is a component, the content of which is extremely difficulty made zero. It is known that Fe₂O₃ that is in an oxidized state becomes a yellow coloring cause, whereas FeO that is in a reduced state becomes a blue coloring cause, and it is known that the glass is occasionally colored green depending upon a balance between the both. In the case where the glass of the present embodiment is used for a cover glass of display, window glass, or solar cell, or the like, it is preferred that its coloration is pale. When the total amount of iron (total Fe) is expressed in terms of Fe₂O₃, the content thereof is preferably 0.15% or less, more preferably 0.10% or less, and still more preferably 0.05% or less.

SO₃ is a refining agent of melting of a glass. In general, the content thereof in the glass is a half or less of the amount to be put thereinto from the raw materials. The content of SO₃ in the glass is 0.02% or more, preferably 0.05% or more, and more preferably 0.1% or more. In addition, the content of SO₃ in the glass is 0.4% or less, preferably 0.35% or less, and more preferably 0.3% or less. When the content of SO₃ is 0.02% or more, the refining is thoroughly achieved, and bubble defects can be inhibited. On the other hand, when the content of SO₃ is 0.4% or less, a defect of sodium sulfate generated in the glass can be inhibited.

Besides, a chloride, a fluoride, or the like may be properly contained as the refining agent for melting of the glass. However, in order to enhance visibility of a display device, such as a touch panel, etc., it is preferred that components having absorption in a visible region and to be incorporated as impurities in the raw materials, such as Fe₂O₃, NiO, Cr₂O₃, etc., are decreased as far as possible, and the content of each of these materials is preferably 0.15% or less and more preferably 0.05% or less as expressed in terms of a mass percentage.

Though the glass of the present invention is substantially composed of the above-described components, other components may also be contained within a range where the object of the present invention is not impaired. In the case of containing such components, a sum total of the contents of those components is preferably 5% or less, more preferably 3% or less, and typically 1% or less. The above-described other components are hereunder exemplarily described.

It is known that in general, ZrO₂ has an effect to increase the compressive stress in the chemical strengthening. However, containing a small amount of ZrO₂ does not produce large effects, which does not worth the cost. In consequence, ZrO₂ may be contained in an arbitrary proportion that the cost can be afforded. In the case of containing ZrO₂, the content thereof is preferably 2% or less, and more preferably 1% or less and 0.5% or less.

For the purposes of lowering the high-temperature viscosity of the glass and lowering the devitrification temperature of the glass, SrO and BaO may be contained in small amounts. SrO or BaO also has an effect to lower the ion exchange rate, and therefore, in the case of containing SrO or BaO, the content is preferably 0.5% or less in terms of SrO or BaO.

For the purpose of improving the meltability at high temperatures of the glass, ZnO may be, for example, contained in an amount of up to 2%. However, in the case of producing a glass by the float method, ZnO is reduced in the float bath to produce product defects. Therefore, the content thereof is preferably less than 0.1%, and it is more preferred that ZnO is substantially not contained. The wording “substantially not contained” means that ZnO is not contained in an amount more than the content as an inevitable impurity in the production process.

For the purpose of improving the meltability at high temperature or the glass strength, B₂O₃ may be contained in an amount of less than 1%. In general, when B₂O₃ is contained simultaneously with Na₂O or K₂O as the alkali component, the vaporization becomes vigorous, and the bricks are remarkably corroded. Therefore, the content of B₂O₃ is preferably less than 0.5%, and preferably less than 0.1%. It is preferred that B₂O₃ is substantially not contained.

Li₂O is a component that lowers the strain point and facilitates stress relaxation, and as a result, no stable compressive stress layer is liable to be obtained. Therefore, it is preferred that Li₂O is not contained. Even in the case of containing Li₂O, the content thereof is preferably less than 1%, more preferably less than 0.05%, and especially preferably less than 0.01%.

The composition of the chemically strengthened glass (sheet glass after the chemical strengthening process) according to the present embodiment may be considered to be identical with the composition of the above-described glass for chemical strengthening. Though the Na ion on the glass surface is ion-exchanged with the K ion in the inorganic salt by the chemical strengthening process as described later, such is negligible in terms of a change of the composition of the whole.

### (Chemical Strengthening Process)

The chemical strengthening process is performed in such a manner that the sheet glass is brought into contact with a melt of an alkali metal salt (for example, a potassium nitrate salt) containing an alkali metal ion having a larger ionic radius (typically a K ion) by immersion or other method, whereby a metal ion having a smaller ionic radius (typically an Na ion) in the sheet glass is replaced with the metal ion having a larger ionic radius. According to this, the compressive stress is generated on the sheet glass surface layer due to a difference in an occupying area of the alkali metal ions to form the compressive stress layer.

The process temperature and the process time for bringing the glass into contact with a molten salt containing the alkali metal ion are properly adjusted according to the compositions of the glass and the molten salt. In general, the heating temperature of the molten salt is preferably 350° C. or higher, and more preferably 370° C. or higher. In addition, in general, the heating temperature of the molten salt is preferably 500° C. or lower, and more preferably 450° C. or lower. When the heating temperature of the molten salt is 350° C. or higher, the matter that the ion exchange rate is lowered, so that the chemical strengthening is hardly achieved is prevented from occurring. In addition, when the heating temperature of the molten salt is 500° C. or lower, the decomposition and deterioration of the molten salt can be inhibited.

In general, the time for bringing an aluminosilicate glass into contact with the molten salt is preferably 1 hour or more, and more preferably 2 hours or more for the purpose of imparting a sufficient compressive stress. The time for bringing a soda lime glass into contact with the molten salt is preferably 3 hours or more, and more preferably 4 hours or more, 5 hours or more, and 6 hours or more for the purpose of imparting a deeper compressive stress layer. In addition, in the ion exchange for a long time, not only the productivity drops, but also the compressive stress value is lowered due to relaxation. Therefore, in the case of the aluminosilicate glass, its contact time is preferably 72 hours or less, and more preferably 24 hours or less and 8 hours or less. In the case of the soda lime glass, the time required for the ion exchange is relatively long, and therefore, its contact time is preferably 300 hours or less, and more preferably 200 hours or less and 100 hours or less.

Examples of the molten salt for performing the chemical strengthening process include alkali nitrates, alkali sulfates, and alkali chloride salts, such as potassium nitrate, potassium sulfate, potassium carbonate, potassium chloride, etc., and the like. These molten salts may be used either alone or in combination of plural kinds. In addition, in order to adjust the chemical strengthening properties, a salt containing sodium (Na ion) or lithium (lithium ion) may be mixed.

As the molten salt for performing the chemical strengthening process, a processed salt containing at least a potassium ion is preferably used. As such a processed salt, examples of these suitably include a salt containing 50% by mass or more of potassium nitrate. In addition, the mixed molten salt may also contain other component. Examples of such other component include alkali sulfates, such as sodium sulfate, potassium sulfate, etc.; alkali chloride salts, such as sodium chloride, potassium chloride, etc.; and the like.

In the sheet glass according to the present embodiment, a process condition of the chemical strengthening process is not particularly limited, an optimum condition can be selected taking into consideration the properties of glass, the molten salt, and so on.

The chemical strengthening process may be sequentially performed in continuous steps, for example, online to a glass ribbon continuously moving in a glass sheet production step, and may be performed in online non-continuously.

### (Resin Layer)

As the resin to be contained in the resin layer, generally used known adhesive compositions can be used. Examples thereof include an acrylic resin, a urethane resin, a silicone resin, a phenol resin, an epoxy resin, a melamine resin, a urea resin, an unsaturated polyester resin, an alkyd resin, a polyimide resin, a fluorocarbon resin, and the like. The adhesive composition may be either a copolymer resin resulting from polymerization of some kinds of monomers or a mixture of some kinds of resins. Above all, an acrylic resin and a silicone resin are preferred because of excellent heat resistance, peelability, and transparency.

The Young's modulus of the resin layer is preferably 0.01 to 10 MPa. According to this, it is possible to absorb shock of destruction to make the surface level difference small while keeping the sheet glass in which cracks have been generated. The Young's modulus of the resin layer is more preferably 0.01 to 5 MPa, and still more preferably 0.01 to 1 MPa.

### (Glass Resin Laminate)

FIG. 3 shows one example of a configuration of the glass resin laminate according to the present embodiment. A sheet glass 10 is disposed on an electronic instrument casing 40 via a resin layer 20. The resin layer 20 may be disposed so as to cover the entire surface of the sheet glass 10, or may cover only a part of the sheet glass 10. In addition, it is preferred that the resin layer 20 is adhered especially to a display member 30 in the electronic instrument casing 40 because the transparency of the sheet glass 10 can be thoroughly brought out. The resin layer 20 may cover the entire surface of the displayer member 30, or may cover only a part of the displayer member 30.

The adhesion of the resin layer 20 to the sheet glass 10 is preferably 10 to 1,000 N/m². According to this, even in the case where the sheet glass 10 is destructed to generate cracks, in view of the matter that glass pieces having a size to some extent or larger are adhered to the resin layer 20, the surface level difference can be made small. The adhesion is more preferably 30 to 750 N/m², and still more preferably 50 to 500 N/m². The adhesion of the resin layer 20 is a value measured in conformity with the shear adhesion strength (JIS K6850:1999).

The applications of the sheet glass and the glass resin laminate according to the present embodiments are not particularly limited. Since they have high mechanical strength, they are suitable for use in the portions at which shock by dropping and contact with other materials are expected. For example, the sheet glass and the glass resin laminate according to the present embodiments can be used as a cover glass and a touch sensor glass of a touch panel display equipped in information instruments, such as tablet PCs, notebook-size PCs, smartphones, e-book readers, etc., a cover glass of liquid crystal televisions, PC monitors, etc., a cover glass of automobile instrument panels, etc., a cover glass for solar cells, a multilayer glass for use in interior materials of building materials and windows of buildings and houses, and the like. That is, the sheet glass and glass resin laminate according to the present embodiments have a size suitable for intended applications, such as a size of a display of tablet PCs or smartphones, etc., or a size of a cover glass for solar cells.

### EXAMPLES

Examples corresponding to the glass resin laminate according to the present embodiment are described.

### <Evaluation Methods>

Various evaluations in the present Examples were performed according to the following analysis methods.

### (Evaluation of Glass: Surface Stress)

The surface compressive stress value (CS), the depth of compressive stress layer (DOL), and the central tension (CT) were measured with a glass surface stress meter (FSM-6000LE, manufactured by Orihara Industrial Co., Ltd.).

### (Evaluation of Glass Resin Laminate: Breakage Behavior)

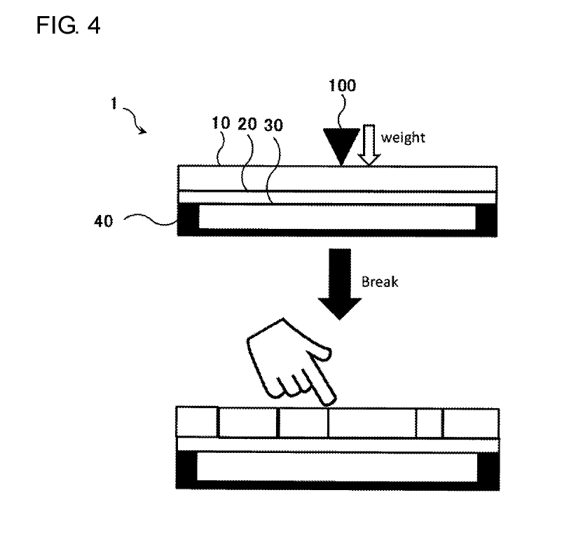

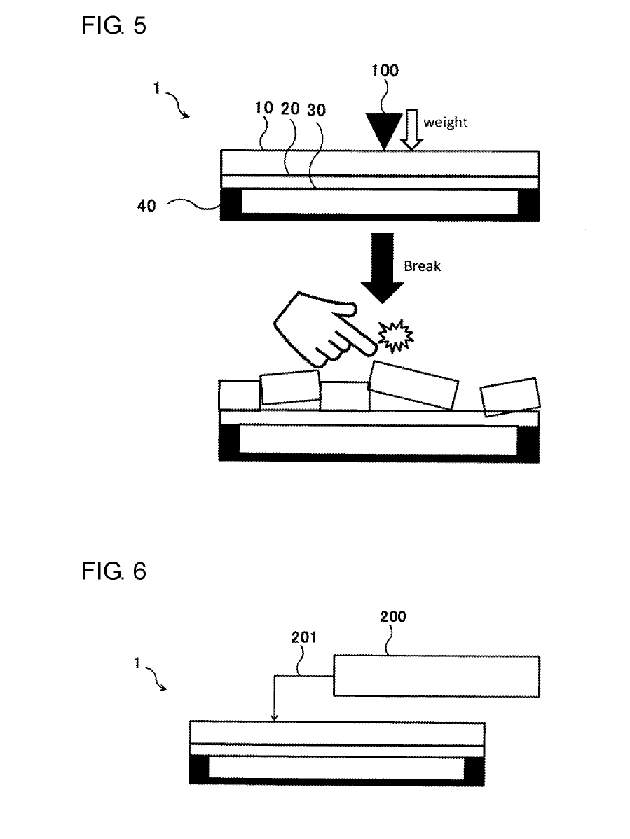

In the case of attaching the cover glass and the electronic instrument casing (particularly the liquid crystal display member) to each other, the breakage behavior of the cover glass was evaluated as follows. The evaluation method is shown by diagrammatic views of FIG. 4 to FIG. 6. First of all, the sheet glass 10 imparted with desired surface compressive stress value (CS), depth of compressive stress layer (DOL), and central tension (CT) is attached to the electronic instrument casing 40 via the resin layer 20, thereby producing a glass resin laminate 1. Subsequently, an indenter is freely fallen from a height of 30 mm in a state where an indenter is attached with a weight of 10 g, and the indenter is collided at a rate of about 0.8 m/sec on the glass, thereby destructing the glass (FIG. 4 and FIG. 5). Subsequently, the surface level difference of the sheet glass 10 was evaluated with a surface texture and contour measuring instrument 200 (SURFCOM 1400D, manufactured by Tokyo Seimitsu Co., Ltd.) (FIG. 6). The surface level difference of the sheet glass 10 as referred to herein is measured as a maximum value of a difference in height between a fragment and a fragment of the glass after destruction.

### Examples 1 to 13

First of all, an aluminosilicate glass made of the following composition and having a size of 50 mm×50 mm×0.2 to 1.0 mm was obtained. Subsequently, an SUS-made cup was charged with potassium nitrate (KNO₃) and sodium nitrate (NaNO₃) in a total amount of 3,500 g and in a concentration (% by mass) of KNO₃ as shown in the column of Chemical strengthening step in Table 2 and heated to a predetermined temperature with a mantle heater, thereby preparing a mixed molten salt of potassium nitrate and sodium nitrate. The aforementioned aluminosilicate glass was preliminarily heated to 425° C. and then immersed in the molten salt for a predetermined time to perform an ion exchange treatment, followed by cooling to the vicinity of room temperature to achieve the chemical strengthening process. A condition of the chemical strengthening process is shown in Table 2. The resulting sheet glass was washed several times with pure water, following by drying by air blowing. Thus, sheet glasses of Examples 1 to 13 were obtained.

Aluminosilicate glass composition (expressed in terms of mol %):

SiO₂: 63%, Al₂O₃: 8%, Na₂O: 13%, K₂O: 4%, MgO: 11%, ZrO₂: 1%

Each of the sheet glasses of Examples 1 to 13 was laminated with a resin layer having a Young's modulus and an adhesion shown in Table 2, thereby obtaining glass resin laminates of Examples 1 to 13.

The obtained glass resin laminates were subjected to various evaluations. The sheet thickness t (mm), the CS value (MPa), the DOL value (μm), and the CT value (MPa) are shown. All of the sheet glasses had a complementary error function profile, and the CT value was determined according to the equation (1). The CT₁ value was determined as CT₁=−38.7×ln(t)+48.2 [MPa] from the sheet thickness t (mm). The CT₄ value as determined as CT₄=64.1×t^{-0.703} [MPa] from the sheet thickness t (mm). The results are shown in Table 2.

TABLE 2

| | | | | | | | | | | Young's | | |
|---|---|---|---|---|---|---|---|---|---|---|---|---|
| | | Chemical strengthening process | | | | | | | | modulus | | Surface |
| | Sheet | Concentration | Strengthening | Strengthening | | | | | | of resin | | level |
| | thickness t | of KNO₃ | time | temperature | CS | DOL | CT | CT₁ | CT₄ | layer | Adhesion | difference |
| No. | [μm] | [% by mass] | [hour] | [° C.] | [MPa] | [μm] | [MPa] | [MPa] | [MPa] | [MPa] | [N/cm²] | [μm] |
| 1 | 0.2 | 100 | 2 | 400 | 815 | 22 | 115 | 110 | 199 | 1 | 100 | <1 |
| 2 | 0.3 | 98 | 1 | 420 | 692 | 20 | 53 | 95 | 149 | 0.1 | 50 | <1 |
| 3 | 0.3 | 99 | 4 | 430 | 735 | 42 | 141 | 95 | 149 | 3 | 300 | <1 |
| 4 | 0.3 | 98 | 5 | 430 | 681 | 45 | 146 | 95 | 149 | 2 | 200 | 22 |
| 5 | 0.5 | 100 | 2 | 425 | 756 | 44 | 81 | 75 | 104 | 10 | 1000 | <5 |
| 6 | 0.5 | 99 | 6 | 430 | 735 | 50 | 91 | 75 | 104 | 7 | 700 | <5 |
| 7 | 0.55 | 99 | 10 | 400 | 735 | 44 | 70 | 71 | 98 | 7 | 700 | 2 |
| 8 | 0.55 | 100 | 8 | 425 | 793 | 54 | 98 | 71 | 98 | 10 | 1000 | >5 |
| 9 | 0.55 | 100 | 10 | 425 | 773 | 60 | 109 | 71 | 98 | 10 | 1000 | >5 |
| 10 | 0.7 | 99 | 6 | 400 | 732 | 35 | 41 | 62 | 82 | 0.1 | 50 | <5 |
| 11 | 0.7 | 100 | 10 | 400 | 832 | 44 | 60 | 62 | 82 | 9 | 900 | <5 |
| 12 | 0.7 | 100 | 8 | 435 | 767 | 60 | 79 | 62 | 82 | 3 | 300 | >5 |
| 13 | 1 | 99 | 6 | 400 | 777 | 35 | 29 | 48 | 64 | 0.1 | 50 | <1 |

### Examples 14 to 30

First of all, an aluminosilicate glass having a size of 50 mm×50 mm×0.2 to 1.0 mm was obtained. Subsequently, an SUS-made cup was charged with potassium nitrate (KNO₃) and sodium nitrate (NaNO₃) in a total amount of 3,500 g and in a concentration (% by mass) of KNO₃ as shown in the column of Chemical strengthening step in Table 3 and heated to a predetermined temperature with a mantle heater, thereby preparing a mixed molten salt of potassium nitrate and sodium nitrate. The aforementioned aluminosilicate glass was preliminarily heated to 425° C. and then immersed in the molten salt for a predetermined time to perform an ion exchange treatment, followed by cooling to the vicinity of room temperature to achieve the chemical strengthening process. A condition of the chemical strengthening process is shown in Table 3. The resulting sheet glass was washed several times with pure water, following by drying by air blowing. Thus, sheet glasses of Examples 14 to 30 were obtained.

Aluminosilicate glass composition (expressed in terms of mol %):

SiO₂: 68%, Al₂O₃: 10%, Na₂O: 14%, MgO: 8%

Each of the sheet glasses of Examples 14 to 30 was laminated with a resin layer having a Young's modulus and an adhesion shown in Table 3, thereby obtaining glass resin laminates of Examples 14 to 30.

The obtained glass resin laminates were subjected to various evaluations. The sheet thickness t (mm), the CS value (MPa), the DOL value (μm), and the CT value (MPa) are shown. All of the sheet glasses had a complementary error function profile, and the CT value was determined according to the equation (1). The CT₁ value was determined as CT₁=−38.7×ln(t)+48.2 [MPa] from the sheet thickness t (mm). The CT₄ value as determined as CT₄=64.1×t^{-0.703} [MPa] from the sheet thickness t (mm). The results are shown in Table 3.

TABLE 3

| | | | | | | | | | | Young's | | |
|---|---|---|---|---|---|---|---|---|---|---|---|---|
| | | Chemical strengthening process | | | | | | | | modulus | | Surface |
| | Sheet | Concentration | Strengthening | Strengthening | | | | | | of resin | | level |
| | thickness t | of KNO₃ | time | temperature | CS | DOL | CT | CT₁ | CT₄ | layer | Adhesion | difference |
| No. | [μm] | [% by mass] | [hour] | [° C.] | [MPa] | [μm] | [MPa] | [MPa] | [MPa] | [MPa] | [N/cm²] | [μm] |
| 14 | 0.2 | 100 | 3 | 425 | 880 | 26 | 157 | 110 | 199 | 5 | 500 | 0.5 |
| 15 | 0.3 | 99 | 8 | 435 | 888 | 45 | 187 | 95 | 149 | 5 | 500 | >5 |
| 16 | 0.3 | 98 | 12 | 430 | 823 | 53 | 225 | 95 | 149 | 10 | 1000 | >5 |
| 17 | 0.5 | 99 | 3 | 435 | 960 | 27 | 57 | 75 | 104 | 0.1 | 50 | <5 |
| 18 | 0.5 | 100 | 6 | 435 | 1013 | 40 | 97 | 75 | 104 | 0.5 | 50 | <5 |
| 19 | 0.5 | 98 | 13 | 435 | 821 | 56 | 117 | 75 | 104 | 5 | 500 | >5 |
| 20 | 0.5 | 98 | 13 | 440 | 823 | 60 | 129 | 75 | 104 | 5 | 500 | >5 |
| 21 | 0.55 | 99 | 3 | 4.25 | 955 | 25 | 48 | 71 | 98 | 0.1 | 50 | 1.5 |
| 22 | 0.55 | 98 | 10 | 435 | 835 | 49 | 91 | 71 | 98 | 3 | 300 | 3.5 |
| 23 | 0.55 | 99 | 10 | 435 | 913 | 48 | 97 | 71 | 98 | 3 | 300 | >5 |
| 24 | 0.7 | 99 | 8 | 435 | 932 | 44 | 67 | 62 | 82 | 2 | 200 | <5 |
| 25 | 0.7 | 100 | 8 | 435 | 988 | 44 | 71 | 62 | 82 | 4 | 400 | <5 |
| 26 | 0.7 | 98 | 14 | 435 | 823 | 59 | 84 | 62 | 82 | 10 | 1000 | >5 |
| 27 | 1 | 98 | 8 | 435 | 861 | 45 | 43 | 48 | 64 | 1 | 100 | <5 |
| 28 | 1 | 100 | 8 | 435 | 1081 | 45 | 53 | 48 | 64 | 2 | 200 | <5 |
| 29 | 1 | 99 | 14 | 435 | 856 | 58 | 56 | 48 | 64 | 5 | 500 | <5 |
| 30 | 1 | 100 | 13 | 435 | 1001 | 56 | 63 | 48 | 64 | 5 | 500 | >5 |

### Examples 31 to 41

First of all, an aluminoborosilicate glass having a size of 50 mm×50 mm×0.2 to 1.0 mm was obtained. Subsequently, an SUS-made cup was charged with potassium nitrate (KNO₃) and sodium nitrate (NaNO₃) in a total amount of 3,500 g and in a concentration (% by mass) of KNO₃ as shown in the column of Chemical strengthening step in Table 4 and heated to a predetermined temperature with a mantle heater, thereby preparing a mixed molten salt of potassium nitrate and sodium nitrate. The aforementioned aluminoborosilicate glass was preliminarily heated to 425° C. and then immersed in the molten salt for a predetermined time to perform an ion exchange treatment, followed by cooling to the vicinity of room temperature to achieve the chemical strengthening process. A condition of the chemical strengthening process is shown in Table 4. The resulting sheet glass was washed several times with pure water, following by drying by air blowing. Thus, sheet glasses of Examples 31 to 41 were obtained.

Aluminoborosilicate glass composition (expressed in terms of mol %):

SiO₂: 67%, B₂O₃: 4%, Al₂O₃: 13%, Na₂O: 14%, MgO: 2%

Each of the sheet glasses of Examples 31 to 41 was laminated with a resin layer having a Young's modulus and an adhesion shown in Table 4, thereby obtaining glass resin laminates of Examples 31 to 41.

The obtained glass resin laminates were subjected to various evaluations. The sheet thickness t (mm), the CS value (MPa), the DOL value (μm), and the CT value (MPa) are shown. The CT₁ value was determined as CT₁=−38.7×ln(t)+48.2 [MPa] from the sheet thickness t (mm). The CT₄ value as determined as CT₄=64.1×t^{-0.703} [MPa] from the sheet thickness t (mm). The results are shown in Table 4.

TABLE 4

| | | | | | | | | | | Young's | | |
|---|---|---|---|---|---|---|---|---|---|---|---|---|
| | | Chemical strengthening process | | | | | | | | modulus | | Surface |
| | Sheet | Concentration | Strengthening | Strengthening | | | | | | of resin | | level |
| | thickness t | of KNO₃ | time | temperature | CS | DOL | CT | CT₁ | CT₄ | layer | Adhesion | difference |
| No. | [μm] | [% by mass] | [hour] | [° C.] | [MPa] | [μm] | [MPa] | [MPa] | [MPa] | [MPa] | [N/cm²] | [μm] |
| 31 | 0.2 | 100 | 1 | 400 | 854 | 16 | 84 | 110 | 199 | 0.1 | 50 | 0.8 |
| 32 | 0.2 | 100 | 5 | 400 | 865 | 33 | 214 | 110 | 199 | 10 | 1000 | >10 |
| 33 | 0.2 | 98 | 5 | 420 | 635 | 41 | 222 | 110 | 199 | 8 | 800 | 10 |
| 34 | 0.2 | 99 | 5 | 420 | 725 | 40 | 243 | 110 | 199 | 5 | 500 | >10 |
| 35 | 0.2 | 100 | 10 | 390 | 849 | 40 | 281 | 110 | 199 | 10 | 1000 | 9 |
| 36 | 0.2 | 100 | 9 | 400 | 816 | 42 | 292 | 110 | 199 | 10 | 1000 | 9 |
| 37 | 0.3 | 100 | 2 | 400 | 851 | 22 | 74 | 95 | 149 | 1 | 700 | 0.5 |
| 38 | 0.3 | 100 | 2 | 420 | 819 | 27 | 88 | 95 | 149 | 1 | 700 | 0.5 |
| 39 | 0.3 | 100 | 3 | 415 | 810 | 31 | 104 | 95 | 149 | 3 | 300 | 0.5 |
| 40 | 0.55 | 99 | 10 | 400 | 702 | 44 | 67 | 71 | 98 | 8 | 800 | 4 |
| 41 | 0.55 | 100 | 8 | 400 | 850 | 40 | 72 | 71 | 98 | 1 | 100 | 3.5 |

### Examples 42 to 47

First of all, a soda lime glass having a size of 50 mm×50 mm×0.2 to 1.0 mm was obtained. Subsequently, an SUS-made cup was charged with potassium nitrate (KNO₃) and sodium nitrate (NaNO₃) in a total amount of 3,500 g and in a concentration (% by mass) of KNO₃ as shown in the column of Chemical strengthening step in Table 5 and heated to a predetermined temperature with a mantle heater, thereby preparing a mixed molten salt of potassium nitrate and sodium nitrate. The aforementioned soda lime glass was preliminarily heated to 425° C. and then immersed in the molten salt for a predetermined time to perform an ion exchange treatment, followed by cooling to the vicinity of room temperature to achieve the chemical strengthening process. A condition of the chemical strengthening process is shown in Table 5. The resulting sheet glass was washed several times with pure water, following by drying by air blowing. Thus, sheet glasses of Examples 42 to 47 were obtained.

Soda lime glass composition (expressed in terms of mol %):

SiO₂: 71%, Al₂O₃: 1%, Na₂O: 12%, K₂O: 1%, MgO: 6%, CaO: 9%

Each of the sheet glasses of Examples 42 to 47 was laminated with a resin layer having a Young's modulus and an adhesion shown in Table 5, thereby obtaining glass resin laminates of Examples 42 to 47.

The obtained glass resin laminates were subjected to various evaluations. The sheet thickness t (mm), the CS value (MPa), the DOL value (μm), and the CT value (MPa) are shown. The CT₁ value was determined as CT₁=−38.7×ln(t)+48.2 [MPa] from the sheet thickness t (mm). The CT₄ value as determined as CT₄=64.1×t^{-0.703} [MPa] from the sheet thickness t (mm). The results are shown in Table 5.

TABLE 5

| | | | | | | | | | | Young's | | |
|---|---|---|---|---|---|---|---|---|---|---|---|---|
| | | Chemical strengthening process | | | | | | | | modulus | | Surface |
| | Sheet | Concentration | Strengthening | Strengthening | | | | | | of resin | | level |
| | thickness t | of KNO₃ | time | temperature | CS | DOL | CT | CT₁ | CT₄ | layer | Adhesion | difference |
| No. | [μm] | [% by mass] | [hour] | [° C.] | [MPa] | [μm] | [MPa] | [MPa] | [MPa] | [MPa] | [N/cm²] | [μm] |
| 42 | 0.2 | 100 | 4 | 435 | 650 | 9 | 32 | 110 | 199 | 0.01 | 10 | <1 |
| 43 | 0.3 | 98 | 4 | 435 | 593 | 9 | 18 | 95 | 149 | 0.01 | 10 | <1 |
| 44 | 0.5 | 97 | 4 | 435 | 565 | 8 | 9 | 75 | 104 | 0.01 | 10 | <1 |
| 45 | 0.55 | 97 | 4 | 435 | 554 | 9 | 9 | 71 | 98 | 0.01 | 10 | <1 |
| 46 | 0.7 | 98 | 4 | 435 | 591 | 8 | 7 | 62 | 82 | 0.01 | 10 | <1 |
| 47 | 1 | 98 | 4 | 435 | 591 | 8 | 5 | 48 | 64 | 0.01 | 10 | <1 |

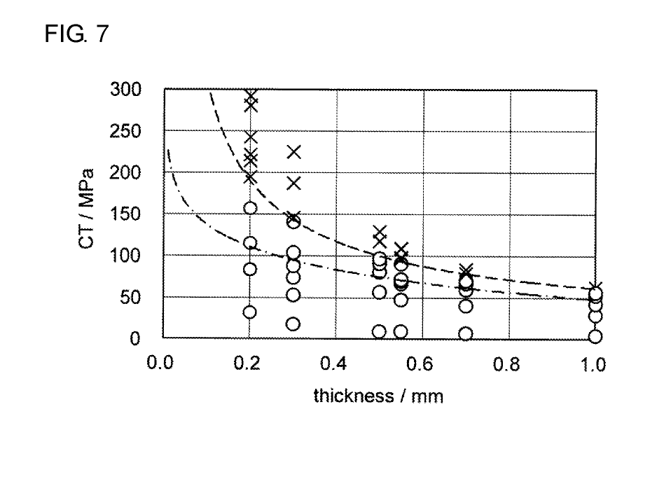

In addition, with respect to each of the samples of Tables 2 to 5, the relation between the sheet thickness and the central stress CT value of the sheet glass was plotted in FIG. 7. In addition, curves corresponding to the CT₁ values were shown. In FIG. 7, the sample in which on destruction, the surface level difference was 5 μm or less was plotted with a symbol “∘”, and the sample in which the surface level difference was more than 5 μm was plotted with a symbol “x”.

From the results of FIG. 7, it has been noted that even among sheet glasses having the CT value of more than the CT₁ value, those having a small surface level difference on destruction are included. This may be considered to be caused due to the matter that by laminating the resin layer having a relatively low Young's modulus with the sheet glass, fragmentation of the sheet glass was inhibited.

In consequence, in the case of the configuration in which the resin layer intervenes between the sheet glass and the electronic instrument casing (or the display member), there is a case where even after the sheet glass is broken, the sheet glass and the resin layer keep the adhered state depending upon a breakage way thereof, thereby making it possible to use the configuration as a protective sheet of the electronic instrument, and its CT value is largely different from the CT₁ value which has hitherto been considered to be an upper limit at which when the glass is broken, it starts to finely scatter according to the evaluation of the sheet glass alone.

On the other hand, from the results of FIG. 7, it has been noted that when the central tension CT of the sheet glass is more than a certain critical value which is different from the CT₁ value determined according to the above-described equation (5) “CT>−38.7×ln(t)+48.2”, on destruction, the surface level difference is largely different. The numerical value corresponding to this critical value can be approximated by a curve. By determining the value of the right side of the equation (4) by the sheet thickness t [mm] shown in Tables 2 to 5 so as to enable the breakage behavior of the sheet glass to be regulated, the curve obtained according to the above-described approximation is shown in FIG. 7.

As shown in Tables 2 to 5 and FIG. 7, in the sheet glasses having the central tension CT of more than 64.1×t^{-0.703} [MPa] in terms of the function of the sheet thickness t [mm], the surface level difference was large. Then, in the present description, the upper limit value of the central tension CT is defined as CT₄=64.1× t^{-0.703}” [MPa].

When the central tension CT satisfies the above-described equation (4) “CT≤64.1×t^{-0.703}” and the above-described equation (5) “CT>−38.7× ln(t)+48.2”, even after the glass is broken, the surface level difference is small, and even after the glass is broken, a user is able to use temporarily with good operability. This condition is the upper limit value of the central tension CT of the sheet glass in the case of the configuration in which the resin layer intervenes between the sheet glass and the electronic instrument casing (or the displayer member), an aspect of which has been found by the inventor of this application as a result of extensive and intensive investigations.

From these results, in the case of the configuration in which the resin layer intervenes between the sheet glass and the electronic instrument casing (or the displayer member), by controlling the central tension CT within the numerical value ranges satisfying the equation (4) and the equation (5), the breakage behavior of the sheet glass can be regulated.

Although preferred embodiments and examples have been described in detail, it should be construed that the present invention is by no means limited by the above-described embodiments and examples and that numerous variations and modifications may be made without departing from the spirit and scope of the present invention. In addition, the above-described respective embodiments can be properly combined with each other.

While the present invention has been described in detail and with reference to specific embodiments thereof, it will be apparent to one skilled in the art that various changes and modifications can be made therein without departing from the spirit and scope thereof. The present application is based on a Japanese patent application filed on Oct. 16, 2015 (Japanese Patent Application No. 2015-204413), the entireties of which are incorporated by reference.

### REFERENCE SIGNS LIST

1: Glass resin laminate
10: Sheet glass
20: Resin layer
30: Display member
40: Electronic instrument casing
100: Indenter
200: Surface texture and contour measuring instrument
201: Probe

1. A glass resin laminate comprising a sheet glass having a compressive stress layer formed in a main surface thereof and a resin layer provided on the sheet glass, wherein
a surface compressive stress in the main surface of the sheet glass is 200 MPa or more, a depth of the compressive stress layer is 3 μm or more, and a central tension CT (MPa) and a sheet thickness t (mm) of the sheet glass satisfy the following equations (4) and (5):
CT≤64.1×t^{-0.703} (4)
CT>−38.7×ln(t)+48.2 (5).

2. The glass resin laminate according to claim 1, wherein a Young's modulus of the resin layer is 0.01 to 10 MPa.

3. The glass resin laminate according to claim 1, wherein an adhesion of the resin layer to the sheet glass is 10 to 1,000 N/m².

4. The glass resin laminate according to claim 1, wherein a safety index of the sheet glass is 2 or more.

5. The glass resin laminate according to claim 1, which is used for an electronic instrument including a liquid crystal display device and disposed for use such that the resin layer intervenes between the sheet glass and the liquid crystal display device.
